(19) United States
(12) Patent Application Publication
(10) Pub. No.: US 2020/0311843 A1
(43) Pub. Date: Oct. 1, 2020

(54) SHUTTLE BUS PASSENGER IDENTIFICATION TERMINAL FOR IDENTIFYING SHUTTLE BUS PASSENGER, SHUTTLE BUS MANAGEMENT SYSTEM, AND METHOD FOR IDENTIFYING SHUTTLE BUS PASSENGER

(71) Applicant: CIEL INC. CO., LTD., Daegu (KR)

(72) Inventor: Muyoul PARK, Daegu (KR)

(73) Assignee: CIEL INC. CO., LTD., Daegu (KR)

(21) Appl. No.: 16/311,079

(22) PCT Filed: Nov. 30, 2016
(86) PCT No.: PCT/KR2016/013960

§ 371 Date: Dec. 18, 2018

(51) Int. Cl. G06Q 50/26; G06Q 50/30; G06Q 20/18; H04L 9/08; G06K 7/14; G06K 7/10

(52) U.S. Cl. CPC G06Q 50/265; G06Q 50/30; G06Q 20/18; H04L 9/0863; G06Q 2220/00; G06K 7/1417; G06K 7/10297; G06Q 2240/00; G06K 7/1413

(57) ABSTRACT

The present disclosure relates to a shuttle bus passenger identification terminal comprising: a communication unit for receiving a boarding code from a user terminal; a storage unit for storing vehicle information; and a processing unit for determining the boarding right of a passenger by comparing vehicle information in the received boarding code with the vehicle information stored in the storage unit. Accordingly, the present disclosure enables fast and simple identification of a shuttle bus passenger just by using simple information, such a route code ora vehicle code.

### TECHNICAL FIELD

The present disclosure relates to a shuttle bus passenger identification terminal, and more particularly, to a shuttle bus passenger identification terminal for identifying a shuttle bus passenger only using simple vehicle information, a shuttle bus management system and a shuttle bus passenger identification method.

### BACKGROUND ART

Conventionally, employee ID cards and student ID cards primarily using a RFID card, a beacon, a QR-CODE, etc. were used to identify shuttle bus passengers, and a passenger identification terminal installed in the vehicle to identify passengers stores and manages passenger information (employee number, RFID card UID, beacon UID, etc.). Shuttle buses run by companies take a large number of employees, and come in various buses and routes. When employees do not determine and use only particular routes and they board vehicles of all routes, it is necessary to update and store a list to identify passengers, or when buses allocated to particular routes vary, it is necessary to newly store and register a passenger list of the corresponding route for each allocated bus.

The relevant prior art document to the present disclosure is ‘Method of passenger check and apparatus thereof (Korean Patent Publication No. 10-2006-0135259)’.

### DISCLOSURE

### Technical Problem

A first object of the present disclosure is to provide a shuttle bus passenger identification terminal for identifying shuttle bus passengers only using simple vehicle information.

A second object of the present disclosure is to provide a shuttle bus management system for identifying shuttle bus passengers only using simple vehicle information.

A third object of the present disclosure is to provide a shuttle bus passenger identification method for identifying shuttle bus passengers only using simple vehicle information.

### Technical Solution

To achieve the first object, the present disclosure provides a shuttle bus passenger identification terminal including a communication unit which receives a boarding code from a user terminal, a storage unit which stores vehicle information, and a processing unit which determines boarding permission of a passenger by comparing vehicle information in the received boarding code with the vehicle information stored in the storage unit.

According to another embodiment of the present disclosure, the shuttle bus passenger identification terminal may be characterized in that the vehicle information stored in the storage unit is a route code, the boarding code is information received by the user terminal from a server, and the boarding code includes a passenger code and a route code stored in the server in encrypted form.

According to another embodiment of the present disclosure, the shuttle bus passenger identification terminal may be characterized in that the vehicle information stored in the storage unit is a unique vehicle code of a corresponding vehicle, the boarding code is information received by the user terminal from a server, and the boarding code includes a passenger code and a vehicle code stored in the server in encrypted form.

According to another embodiment of the present disclosure, the shuttle bus passenger identification terminal may be characterized in that the storage unit does not store shuttle bus passenger information, or is not synchronized with a server that stores shuttle bus passenger information.

According to another embodiment of the present disclosure, the shuttle bus passenger identification terminal may be characterized in that the boarding code is information that is encrypted on a server using an encryption key generated by a one-time encryption key generator.

According to another embodiment of the present disclosure, the shuttle bus passenger identification terminal may be characterized in that the processing unit decrypts the boarding code using a decryption key generated by a one-time encryption key generator.

According to another embodiment of the present disclosure, the shuttle bus passenger identification terminal may be characterized in that the communication unit transmits boarding/deboarding information after approved boarding of the user terminal to a server together with vehicle information.

To achieve the second object, the present disclosure provides a shuttle bus management system including a user terminal which transmits a boarding pass generation request to a server together with a passenger code, receives a boarding code from the server in response to the boarding pass generation request, and transmits the boarding code to a shuttle bus passenger identification terminal, the shuttle bus passenger identification terminal which receives the boarding code from the user terminal, determines boarding permission of a passenger by comparing vehicle information in the received boarding code with stored vehicle information, and transmits boarding/deboarding information after approved boarding of the user terminal to the server together with the vehicle information, and the server which receives the boarding pass generation request from the user terminal, encrypts vehicle information of a vehicle that the corresponding passenger will board and transmit it to the user terminal, and receives and manages the boarding/deboarding information from the shuttle bus passenger identification terminal, wherein the vehicle information used for the shuttle bus passenger identification terminal to determine the boarding permission is a route code or a unique vehicle code of the corresponding vehicle.

To achieve the third object, the present disclosure provides a shuttle bus passenger identification method including receiving a boarding code from a user terminal, and determining boarding permission of a passenger by comparing vehicle information in the received boarding code with vehicle information stored in a storage unit, wherein the vehicle information for determining the boarding permission is a route code or a unique vehicle code of a corresponding vehicle.

According to another embodiment of the present disclosure, the shuttle bus passenger identification method may further include, after receiving the boarding code from the user terminal, decrypting the received boarding code using a decryption key generated by a one-time encryption key generator.

According to another embodiment of the present disclosure, the shuttle bus passenger identification method may further include, as a result of determining the boarding permission of the passenger, when the passenger is determined to have the boarding permission, transmitting boarding/deboarding information after approved boarding of the user terminal to a server together with vehicle information.

### Advantageous Effects

According to the present disclosure, it is possible to identify shuttle bus passengers quickly and conveniently only using simple information such as a route code or a vehicle code. Through this, there is no need to store a list of shuttle bus passengers or update it through synchronization, and thus the speed is high and problems that may occur due to a communication failure can be solved. Even though vehicle allocation to routes varies, if only route information is updated, it is possible to identify passengers, thereby enhancing passenger convenience and achieving efficient shuttle bus management.

### DESCRIPTION OF DRAWINGS

FIG. 1 is a block diagram of a shuttle bus passenger identification terminal according to an embodiment of the present disclosure.

FIG. 2 is a block diagram of a shuttle bus management system according to an embodiment of the present disclosure.

FIGS. 3 and 4 show information transmitted and received among a passenger identification terminal, a user terminal and a server in a shuttle bus management system according to an embodiment of the present disclosure.

FIG. 5 is a flowchart of a shuttle bus passenger identification method according to an embodiment of the present disclosure.

FIG. 6 is a flowchart of a shuttle bus passenger identification method according to another embodiment of the present disclosure.

### BEST MODE

A shuttle bus passenger identification terminal according to an embodiment of the present disclosure includes a communication unit to receive a boarding code from a user terminal, a storage unit to store vehicle information, and a processing unit to determine boarding permission of a passenger by comparing vehicle information in the received boarding code with the vehicle information stored in the storage unit.

### Mode for Invention

Prior to a detailed description of the present disclosure, an overview of a solution to the problem to be solved by the present disclosure or the essential part of the technical idea is first presented for convenience of understanding.

A shuttle bus passenger identification terminal according to an embodiment of the present disclosure includes a communication unit to receive a boarding code from a user terminal, a storage unit to store vehicle information, and a processing unit to determine boarding permission of a passenger by comparing vehicle information in the received boarding code with the vehicle information stored in the storage unit.

The embodiments will be described in sufficient detail to enable those skilled in the art to easily practice the present disclosure with reference to the accompanying drawings. However, these embodiments are provided to describe the present disclosure more particularly, and it will be obvious to those skilled in the art that the scope of the present disclosure is not limited thereby.

Note that the configuration of the present disclosure for specifying the solution to the problem to be solved by the present disclosure is described in detail with reference to the accompanying drawings based on the preferred embodiments of the present disclosure, but when describing a corresponding drawing, the elements of the other drawings may be quoted if necessary. Additionally, in describing the operation principle of the preferred embodiments of the present disclosure in detail, when a certain detailed description of relevant known function or element of the present disclosure and any other matters is determined to render the key subject matter of the present disclosure unnecessarily vague, the detailed description is omitted herein.

Below is an example that takes place during passenger identification in the conventional shuttle bus.

First, in case the number of employees that board shuttle bus vehicles is large (in the case of a company), employee turnover is high and employees are permitted to board vehicles of all routes (Case 1), it is necessary to receive employee information in a boarding list from server and store it in a database of a shuttle bus passenger identification terminal disposed in the vehicle, and update a change in employee. Or, in case that shuttle bus vehicles are not allocated to only particular routes and they are allocated to different routes, and fares are different depending on the shuttle bus routes (Case 2), each time a vehicle is allocated to a route, it is necessary to delete passenger information of the existing route and newly update passenger information of the corresponding route.

As described above, in the case of a shuttle bus that needs to update passenger information frequently, there are the following problems:

i. Large amounts of mobile communication data is used and passenger data synchronization slows down. To update passenger data every day, it is necessary download a large amount of data from server (Case 1), and a mobile communication network should be used according to the characteristics of vehicles, so an amount of mobile communication data used is too large. In addition, because of the process of downloading a large amount of data and formatting it in a flash memory, it takes a considerable amount of time (actually about 10 minutes required) and a passenger identification task is impossible during data synchronization.

ii. Data stability is low. A low-specification Micom terminal is usually used as the passenger identification terminal of the vehicle, and a passenger DB is managed in an internal flash memory. However, due to the problem with frequent power On/Off and noise according to the characteristics of vehicles, a file system is often broken or unstable.

iii. Data inaccuracy may occur. Because updates are performed once a day, the accuracy of passenger identification may reduce due to un-updated information associated with new employees or employees who left.

iv. Data integrity is low. In a situation of synchronization of a large amount of data with server or during data transmission and reception while moving according to characteristics of vehicles, data being synchronized may be inaccurate due to poor communication conditions such as signal disconnection or speed reduction.

v. Response rate may go down. When passengers queue to board the bus, the passenger identification terminal should perform RFID recognition and boarding permission identification quickly, but when a large amount of passenger data (60,000) is stored in a Micom terminal whose performance is not high, the response rate is lowered and the passengers are forced to wait.

vi. Due to the shortened lifespan of the flash memory, a failure may occur. According to the characteristics of the flash memory having a fixed maximum number of writes, when data updates (writes) are performed frequently as in Case 2, the lifespan of the memory is shortened and the passenger identification terminal may fail.

vii. There is a possibility of data leaks. As a passengers private information (employee number, RFID card number, etc.) is embedded in the “passenger identification terminal” installed in the bus used to move, there is a high possibility of private information and security data leaks. Particularly, in many cases, a company access card and a boarding card are equally used, so company access security may be easily threatened by hacking of the “passenger identification terminal” (because the depot of the bus is not a company, anyone may easily access or steal the “passenger identification terminal”).

viii. Copying of employee ID cards may be possible. When a “passenger identification terminal” and a passenger identification medium such as an employee ID card are possessed, data transmitted and received between the “passenger identification terminal” and the employee ID card may be intercepted and the employee ID card may be easily copied.

ix. Server-linked authentication may be impossible. Because of being connected to a mobile communication network and installed in a moving vehicle, a communication environment is not good (in the case of Hanjin Heavy Industries & Construction in Subic, Philippine, as actually done at site, 70% of the routes along which the commuter vehicles move is a mobile dead spot), which makes it impossible to apply an authentication method via real-time connection with server without embedding authentication related information in the terminal itself.

To solve the problems that may occur in the conventional shuttle bus operation method described above, a shuttle bus passenger identification terminal according to an embodiment of the present disclosure ensures convenience of shuttle bus passenger identification and security of information only using simple information without updating a large amount of data. Hereinafter, the shuttle bus passenger identification terminal according to an embodiment of the present disclosure will be described in detail.

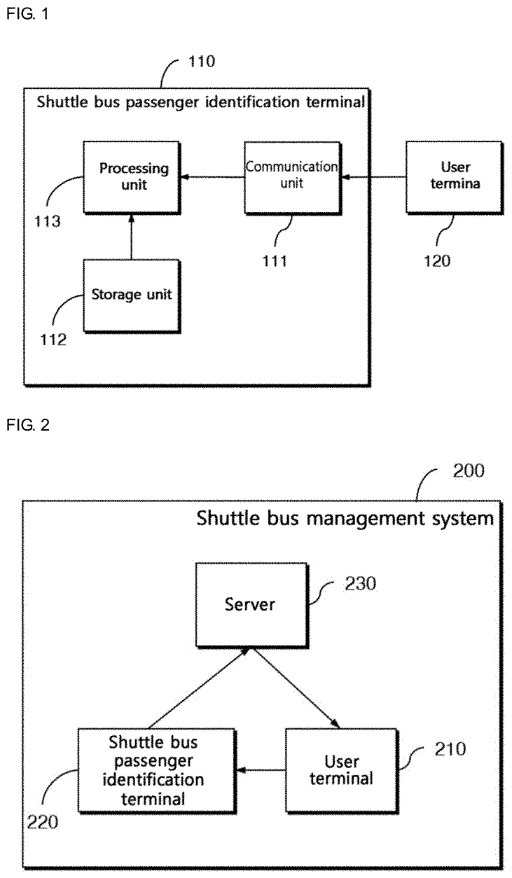

FIG. 1 is a block diagram of the shuttle bus passenger identification terminal according to an embodiment of the present disclosure.

The shuttle bus passenger identification terminal 110 according to an embodiment of the present disclosure includes a communication unit 111, a storage unit 112 and a processing unit 113.

The communication unit 111 receives a boarding code from a user terminal 120. When a passenger boards a vehicle, the communication unit 111 receives the boarding code from the user terminal 120 that the passenger has. The user terminal 120 may be a mobile terminal such as a smartphone, or a boarding pass such as an employee ID card including communication and storage functions. The boarding code is information that a server generates in response to a boarding pass generation request of the passenger and the user terminal 120 receives from the server. The communication unit 111 may be implemented as a QR code reader, a barcode reader, a NFC reader or a BLE terminal (in the case of beacon) according to the storage type of the boarding code, to communicate with the user terminal 120.

The storage unit 112 stores vehicle information. The storage unit 112 stores vehicle information necessary to compare with vehicle information included in the boarding code received from the user terminal 120.

The processing unit 113 determines boarding permission of the passenger by comparing vehicle information in the received boarding code with the vehicle information stored in the storage unit. The processing unit 113 reads vehicle information from the boarding code, compares it with the vehicle information stored in the storage unit 112, determines if the passenger has the boarding permission, and approves the passenger's boarding.

The vehicle information for determining the boarding permission of the passenger may use a route code or a unique vehicle code of the vehicle. As only the route code or the unique vehicle code is used to identify the passenger, there is no need to store shuttle bus passenger information or synchronize with a server that stores shuttle bus passenger information that has caused the problem of the conventional shuttle bus.

In the case of using the route code, the storage unit 112 does not store passenger information such as a passenger list and use it for identification, and only stores the route code as vehicle information. In case that the route to which the vehicle is allocated is constant, the storage unit 112 stores only one route code, and in case that the route is variable, the storage unit 112 synchronizes only allocation information with the server and updates only the route code. When the server receives the boarding pass generation request from the passenger, the server generates a boarding code using the route code that the passenger intends to board, and transmits it to the user terminal 120. In this instance, the boarding code generated by the server may include a passenger code and a route code stored in the server in encrypted form.

In the case of using the unique vehicle code of the vehicle, the storage unit 112 does not store passenger information such as a passenger list and use it for identification, and stores only the vehicle code as vehicle information. Since the unique vehicle code is fixed information, there is no need to update the vehicle information stored in the storage unit 112. When the server receives the boarding pass generation request from the passenger, the server generates a boarding code using the vehicle code allocated to the route that the passenger intends to board, and transmits it to the user terminal 120. In this instance, the boarding code generated by the server may include a passenger code and a vehicle code stored in the server in encrypted form.

The boarding code may be information that is encrypted on the server using an encryption key generated by a one-time encryption key generator. To prevent the problem with hacking or copying of the boarding code, a one-time encryption key generator such as an OTP generator may be used in generating the boarding code. The server may generate the boarding code by encryption using the encryption key generated by the one-time encryption key generator.

In case that the boarding code is encrypted, the processing unit 113 may decrypt the boarding code using a decryption key generated by a one-time encryption key generator. To read the vehicle code by decrypting the encrypted boarding code, the processing unit 113 may use a one-time encryption key generator such as an OTP generator. The processing unit 113 may read vehicle information by decrypting the boarding code using the encryption key generated by the one-time encryption key generator, and compare it with the vehicle information stored in the storage unit 112.

When boarding of the shuttle bus passenger is approved through vehicle information comparison of the processing unit 113, the communication unit 111 may transmit boarding/deboarding information after the approved boarding of the user terminal 120 to the server together with the vehicle information. For shuttle bus passenger management of the server, boarding/deboarding information may be transmitted to the server. The corresponding transmission may be performed in real time or periodically, and as it is ex-post information and it may be unnecessary to transmit information in real time, transmission may be performed according to the communication environment. The boarding/deboarding information may include the passenger code, the boarding time, the vehicle code and the route code. The boarding/deboarding information may be used to manage the shuttle bus, for example, control the number of passengers and allocate the shuttle bus.

A shuttle bus management system 200 of FIG. 2 may be implemented using the shuttle bus passenger identification terminal as described above. The shuttle bus management system 200 includes a user terminal 210, a shuttle bus passenger identification terminal 220 and a server 230. The detailed description of the shuttle bus management system 200 corresponds to the detailed description of the shuttle bus passenger identification terminal 110 of FIG. 1, and an overlapping description is omitted herein.

The user terminal 210 transmits a boarding pass generation request to the server 230 together with a passenger code, receives a boarding code from the server 230 in response to the boarding pass generation request, and transmits the boarding code to the shuttle bus passenger identification terminal 220.

The shuttle bus passenger identification terminal 220 receives the boarding code from the user terminal 210, determines boarding permission of the passenger by comparing vehicle information in the received boarding code with stored vehicle information, and transmits boarding/deboarding information after approved boarding of the user terminal 210 to the server 230 together with the vehicle information. The vehicle information used for the shuttle bus passenger identification terminal 220 to determine the boarding permission is a route code or a unique vehicle code of the corresponding vehicle.

The server 230 receives the boarding pass generation request from the user terminal 210, encrypts the vehicle information of the vehicle that the corresponding passenger will board and transmits it to the user terminal 210, and receives and manages the boarding/deboarding information from the shuttle bus passenger identification terminal 220.

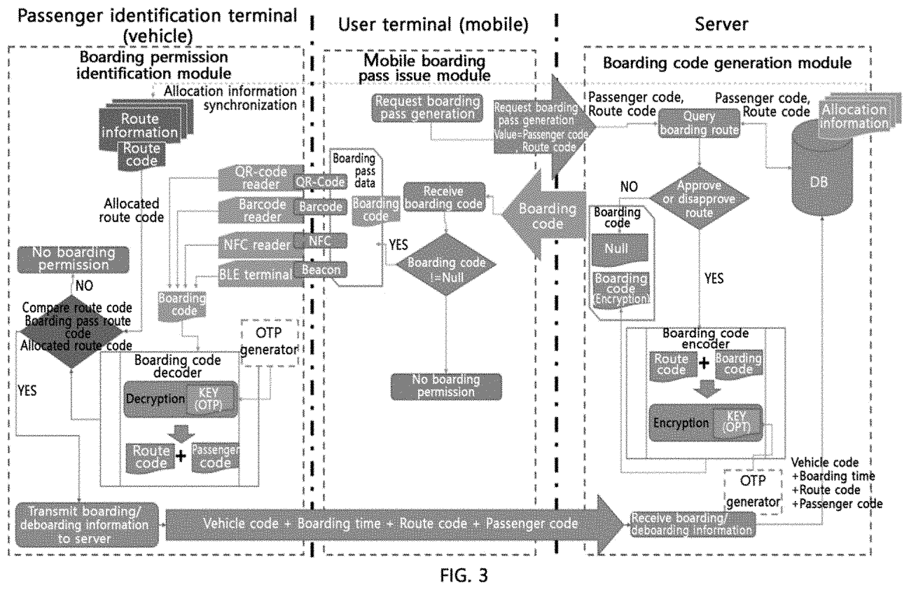

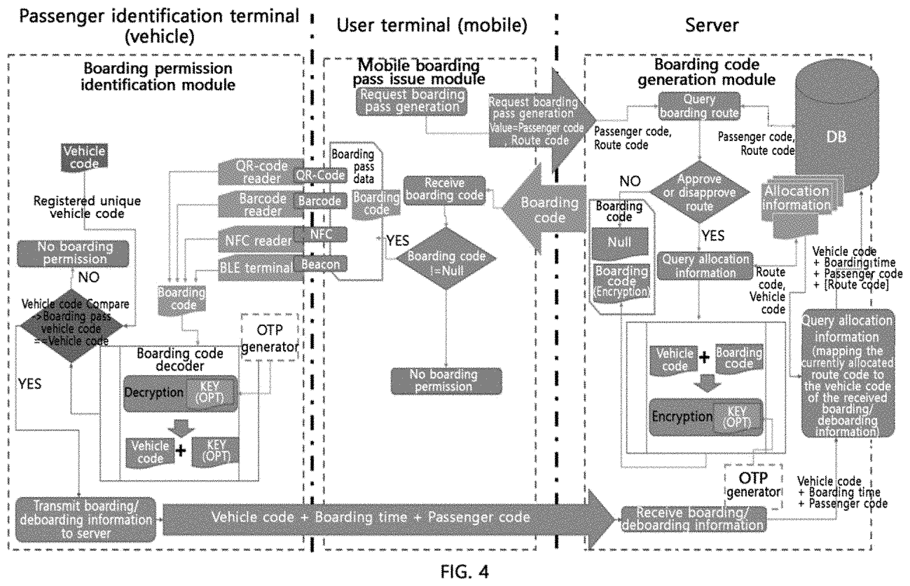

FIGS. 3 and 4 are detailed diagrams showing information transmitted and received among the passenger identification terminal, the user terminal and the server in the shuttle bus management system according to an embodiment of the present disclosure.

FIG. 3 is a diagram a case of identifying boarding permission of a passenger only using a route code. When a boarding pass generation request is selected on the user terminal, the boarding code generation request is transmitted from the user terminal to the server. The boarding code generation request includes a passenger code and a route code that the passenger intends to board. The server having received the boarding code generation request queries a boarding route using allocation information stored in database, and determines passenger route approval or disapproval for the corresponding route. The allocation information stored in the server is information that is synchronized with the passenger identification terminal. When approved, a boarding code encoder encrypts the route code, which is information for passenger identification, together with the passenger code. In this instance, an encryption key is generated using an OTP generator, and the route code and the passenger code are encrypted to generate a boarding code. The server transmits the encrypted boarding code to the user terminal. When the user terminal receives the approved boarding code, the user terminal may convert the corresponding boarding code into a boarding pass. The boarding pass data may be processed into a QR code, a barcode, a NFC and a beacon. When boarding the vehicle, the user terminal transmits the boarding code through communication with the passenger identification terminal disposed in the vehicle. The passenger identification terminal may change in the communication type depending on the type of boarding pass. Because the received boarding code is encrypted, decryption is necessary. A decryption key is generated using an OTP generator, and the route code and the passenger code are read from the boarding code. The read route code is compared with only the route code stored in the passenger identification terminal to identify boarding permission. When the route codes are equal, the corresponding passenger is determined to have the boarding permission, boarding is approved, and consequential boarding/deboarding information is transmitted to the server. The boarding/deboarding information includes the vehicle code, the boarding time, the route code and the passenger code, and the server having received the boarding/deboarding information stores it, and uses for shuttle bus management.

FIG. 4 is a diagram showing a case of identifying boarding permission of a passenger only using a vehicle code. The process is similar to that of the case of FIG. 3 only using a route code, but as opposed to the route code, the vehicle code is a unique code of the corresponding vehicle, and does not need synchronization. The server additionally performs determination as to which vehicle has been allocated to the route that the passenger intends to board. After determining route approval or disapproval, the server queries allocation information, generates a boarding code by encryption using the allocated vehicle code, and transmits it to the user terminal. The passenger identification terminal having received the boarding code from the user terminal reads the vehicle code by decrypting the boarding code, compares it with the unique vehicle code of the corresponding vehicle, and determines boarding permission. When the boarding permission is approved, boarding/deboarding information is transmitted to the server. In this instance, the boarding/deboarding information includes the vehicle code, the boarding time, and the passenger code. The server may manage allocation information by mapping the currently allocated route code to the vehicle code of the received boarding/deboarding information.

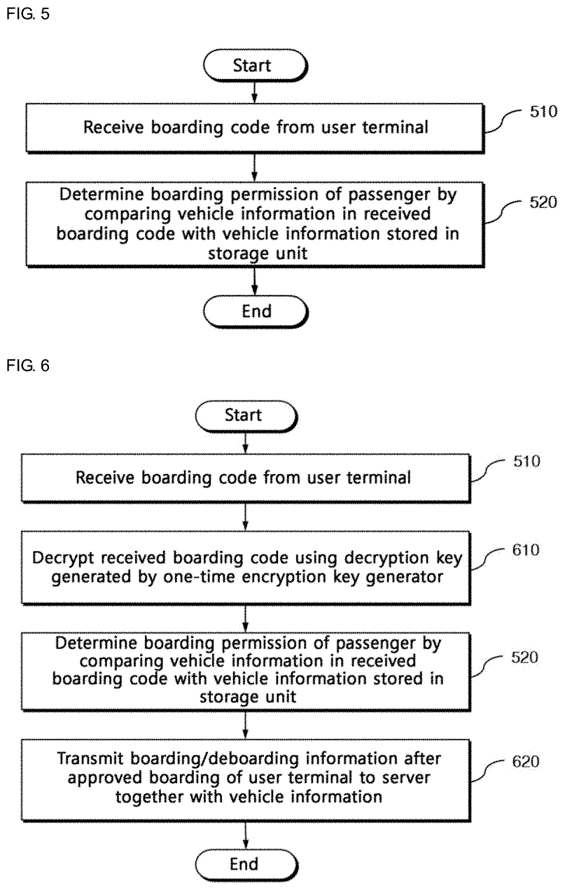

FIG. 5 is a flowchart of a shuttle bus passenger identification method according to an embodiment of the present disclosure, and FIG. 6 is a flowchart of a shuttle bus passenger identification method according to another embodiment of the present disclosure. A detailed description of FIGS. 5 and 6 corresponds to the detailed description of the shuttle bus passenger identification terminal or the shuttle bus management system of FIGS. 1 to 4, and an overlapping description is hereinafter omitted herein.

In 510, a boarding code is received from a user terminal.

In 520, boarding permission of a passenger is determined by comparing vehicle information in the received boarding code with vehicle information stored in the storage unit. In this instance, the vehicle information for determining the boarding permission is a route code or a unique vehicle code of the corresponding vehicle.

In 610, the received boarding code is decrypted using a decryption key generated by a one-time encryption key generator, wherein the boarding code may be encrypted on the server for the purpose of security, and after 510 of receiving the boarding code from the user terminal, the received boarding code may be decrypted using a decryption key generated by a one-time encryption key generator.

In 620, boarding/deboarding information after approved boarding of the user terminal is transmitted to the server together with the vehicle information, and as a result of determining the boarding permission of the passenger in 520, when the passenger is determined to have the boarding permission, boarding/deboarding information after approved boarding of the user terminal is transmitted to the server together with the vehicle information, to enable the server to manage the shuttle bus using the corresponding information.

The embodiments of the present disclosure may be implemented in the form of program commands that can be executed through various computer means, and recorded in computer-readable recording media. The computer-readable recording media may include program commands, data files and data structures, alone or in combination. The program commands in recorded in the media may be specially designed and configured for the present disclosure, and may be known and available to those having ordinary skill in the field of computer software. Examples of the computer-readable recording media include hardware devices specially designed to store and execute program commands, such as magnetic media such as hard disk, floppy disk and magnetic tape, optical recording media such as CD-ROM and DVD, magneto-optical media such as floptical disk, and ROM, RAM and flash memory. Examples of the program commands include machine codes generated by a compiler as well as high-level language codes that can be executed by a computer using an interpreter. The hardware device may be configured to act as one or more software modules to perform the operation of the present disclosure, or vice versa.

While the present disclosure has been hereinabove described with regard to particular subject matters such as specific elements and a limited number of embodiments and drawings, this is only provided to help a more comprehensive understanding of the present disclosure, and it will be apparent from the description that the present disclosure is not limited to the above embodiments and a variety of modifications and changes may be made by those skilled in the art.

Therefore, the spirit of the present disclosure should not be defined as limited to the disclosed embodiments, and the spirit and scope of the present disclosure shall cover the appended claims and all the equivalents and variations to which the appended claims are entitled.

### INDUSTRIAL APPLICABILITY

The present disclosure relates to a shuttle bus passenger identification terminal, including a communication unit to receive a boarding code from a user terminal, a storage unit to store vehicle information, and a processing unit to determine boarding permission of a passenger by comparing vehicle information in the received boarding code with the vehicle information stored in the storage unit, thereby identifying the shuttle bus passenger quickly and conveniently only using simple information such as a route code or a vehicle code.

1. A shuttle bus passenger identification terminal, comprising:
a communication unit which receives a boarding code from a user terminal;
a storage unit which stores vehicle information; and
a processing unit which determines boarding permission of a passenger by comparing vehicle information in the received boarding code with the vehicle information stored in the storage unit.

2. The shuttle bus passenger identification terminal according to claim 1, wherein the vehicle information stored in the storage unit is a route code,
the boarding code is information received by the user terminal from a server, and
the boarding code includes a passenger code and a route code stored in the server in encrypted form.

3. The shuttle bus passenger identification terminal according to claim 1, wherein the vehicle information stored in the storage unit is a unique vehicle code of a corresponding vehicle,
the boarding code is information received by the user terminal from a server, and
the boarding code includes a passenger code and a vehicle code stored in the server in encrypted form.

4. The shuttle bus passenger identification terminal according to claim 1, wherein the storage unit does not store shuttle bus passenger information, or is not synchronized with a server that stores shuttle bus passenger information.

5. The shuttle bus passenger identification terminal according to claim 1, wherein the boarding code is information that is encrypted on a server using an encryption key generated by a one-time encryption key generator.

6. The shuttle bus passenger identification terminal according to claim 1, wherein the processing unit decrypts the boarding code using a decryption key generated by a one-time encryption key generator.

7. The shuttle bus passenger identification terminal according to claim 1, wherein the communication unit transmits boarding/deboarding information after approved boarding of the user terminal to a server together with vehicle information.

8. A shuttle bus management system, comprising:
a user terminal which transmits a boarding pass generation request to a server together with a passenger code, receives a boarding code from the server in response to the boarding pass generation request, and transmits the boarding code to a shuttle bus passenger identification terminal;
the shuttle bus passenger identification terminal which receives the boarding code from the user terminal, determines boarding permission of a passenger by comparing vehicle information in the received boarding code with stored vehicle information, and transmits boarding/deboarding information after approved boarding of the user terminal to the server together with the vehicle information; and
the server which receives the boarding pass generation request from the user terminal, encrypts vehicle information of a vehicle that the corresponding passenger will board and transmit it to the user terminal, and receives and manages the boarding/deboarding information from the shuttle bus passenger identification terminal,
wherein the vehicle information used for the shuttle bus passenger identification terminal to determine the boarding permission is a route code or a unique vehicle code of the corresponding vehicle.

9. A shuttle bus passenger identification method, comprising:
receiving a boarding code from a user terminal; and
determining boarding permission of a passenger by comparing vehicle information in the received boarding code with vehicle information stored in a storage unit,
wherein the vehicle information for determining the boarding permission is a route code or a unique vehicle code of a corresponding vehicle.

10. The shuttle bus passenger identification method according to claim 9, further comprising:
after receiving the boarding code from the user terminal,
decrypting the received boarding code using a decryption key generated by a one-time encryption key generator.

11. The shuttle bus passenger identification method according to claim 9, further comprising:
as a result of determining the boarding permission of the passenger, when the passenger is determined to have the boarding permission, transmitting boarding/deboarding information after approved boarding of the user terminal to a server together with vehicle information.
